(19) United States
(12) Patent Application Publication
(10) Pub. No.: US 2017/0162104 A1
(43) Pub. Date: Jun. 8, 2017

(54) METHOD AND ELECTRONIC DEVICE FOR ALLEVIATING LIGHT LEAKAGE OF MONITOR

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Yang Lin, Tianjin (CN); Yong Wu, Tianjin (CN)

(21) Appl. No.: 15/231,716

(22) Filed: Aug. 8, 2016

Related U.S. Application Data
(63) Continuation of application No. PCT/CN2016/088111, filed on Jul. 1, 2016.

(30) Foreign Application Priority Data
Dec. 8, 2015 (CN) 201510896510.6

(51) Int. Cl. G09G 3/20

(52) U.S. Cl. CPC G09G 3/2092; G09G 2320/0233; G09G 2330/00

(57) ABSTRACT

Disclosed are a method and an electronic device for alleviating light leakage of a monitor. The method includes: a display mode acquiring step: acquiring current image display mode of the monitor; and a luminance adjustment step: adjusting luminance value of display area of the monitor according to the image display mode, wherein the display area is a screen edge area of the monitor. Light leakage of the monitor is alleviated by adjusting the luminance value of the screen edge area of the monitor, which reduces costs for alleviating the light leakage of the monitor.

### CROSS-REFERENCE TO RELATED APPLICATIONS

This application is a continuation application of International Application No. PCT/CN2016/088111, which claims priority to Chinese Patent Application No. 201510896510.6, filed on Dec. 8, 2015 and entitled “METHOD AND APPARATUS FOR ALLEVIATING LIGHT LEAKAGE OF MONITOR”, the entire contents of which are incorporated herein by reference.

### TECHNICAL FIELD

The present application relates to the field of monitors, and in particular, to a method and an electronic device for alleviating light leakage of a monitor.

### BACKGROUND

During design and development of ultrathin liquid crystal display televisions, due to a matching issue between the structure of a television power supply board and the structure of a liquid crystal display screen, the screen of the liquid crystal display television always has the problem of light leakage, causing very poor user experience.

In the prior art, in order to solve the foregoing problem, a driver board with a Local Dimming control function for local backlight is typically used to control the backlight of the screen of the liquid crystal display television, so as to solve the light leakage problem. However, to solve the light leakage problem by using this driver board needs relatively high costs, and the overall price of the television will increase.

Therefore, it is necessary to provide a low-cost method to solve the light leakage problem of the television screen.

### SUMMARY

In view of the foregoing problem, the present application provides a method for alleviating light leakage of a monitor, wherein the light leakage problem of a television screen is solved by using a method of adjusting a luminance value of a screen edge area of the monitor according to an image display mode.

According to a first aspect, the present application provides a method for alleviating light leakage of a monitor, including:
a display mode acquiring step: acquiring a current image display mode of the monitor; and
a luminance adjustment step: adjusting a luminance value of a display area of the monitor according to the image display mode, wherein the display area is a screen edge area of the monitor.

According to a second aspect, the present application further provides a nonvolatile computer storage media having computer executable instructions stored thereon, wherein the computer executable instructions are used to perform any one of the foregoing methods for alleviating light leakage of a monitor of the present application.

According to a third aspect, the present application further provides an electronic device, including: one or more processors; and a memory; wherein the memory is stored with instructions that can be executed by the one or more processors, the instructions are configured to execute any one of the foregoing methods for alleviating light leakage of a monitor of the present application.

The foregoing technical solutions have the following advantageous effects:

The method of acquiring a current image display mode of a monitor, and adjusting the current value of a light bar mounted on a monitor power supply board according to the image display mode so as to adjust a luminance value of a screen edge area, which corresponds to the light bar, of the monitor alleviates the light leakage problem of the monitor, and meanwhile, this method is a low-cost solution.

### BRIEF DESCRIPTION OF THE DRAWINGS

For a better understanding of the embodiments of the invention or the technical solutions in prior art, the drawings employed in the embodiments or the prior art will be described briefly. Apparently, the following description of the drawings are some embodiments of the invention, those of ordinary skill in the art can derive other drawings from these drawings without creative efforts.

FIG. 1 is a flowchart illustrating a method for alleviating light leakage of a monitor according to an embodiment of the present application.

FIG. 2 is a flowchart illustrating a method for alleviating light leakage of a monitor according to another embodiment of the present application.

FIG. 3 is a block diagram illustrating an apparatus for alleviating light leakage of a monitor according to another embodiment of the present application.

FIG. 4 is a schematic diagram of hardware configuration of a device for a method for alleviating light leakage of a monitor in accordance with an embodiment of the present application.

### DETAILED DESCRIPTION

The present application is described in further detail below with reference to specific implementation solutions and accompanying drawings. It is merely intended to illustrate the specific implementation solutions of the present application in detail, but does not constitute any limitation on the present application. The protection scope of the present application is subject to the claims.

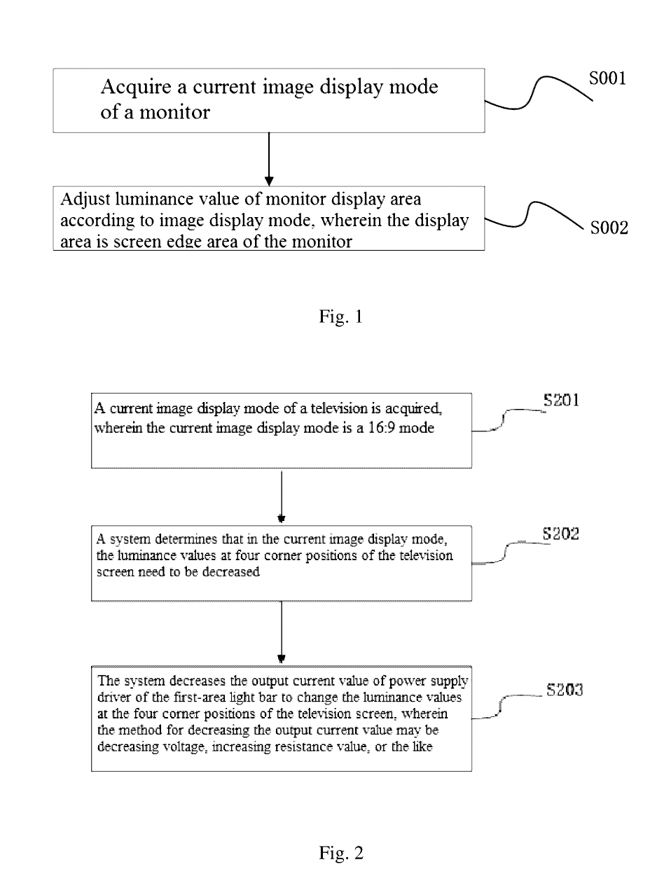

Referring to FIG. 1, an embodiment of the present application provides a method for alleviating light leakage of a monitor, including: a display mode acquiring step S001, in which a current image display mode of the monitor is acquired; and a luminance adjustment step S002, in which a luminance value of a display area of the monitor is adjusted according to the image display mode, wherein the display area is a screen edge area of the monitor. In step S001, the monitor includes: a monitor of a PC, a television monitor, or the like. If the current monitor is a television, the current image display mode, such as full-black-screen display, full-screen display, or 16:9 mode display, is obtained from a television system. In Step S002, a luminance value of a display area on the periphery of the television screen is adjusted according to different display modules, so as to alleviate light leakage of the television screen.

The method of acquiring a current image display mode of a monitor, and adjusting a current value of a light bar mounted on a monitor power supply board according to the image display mode so as to adjust a luminance value of a screen edge area, which corresponds to the light bar, of the monitor alleviates the light leakage problem of the monitor, and meanwhile, this method is a low-cost solution.

In one of the embodiments, in the luminance adjustment step, the luminance value of the display area of the monitor is adjusted by changing current values of light bars mounted on a monitor power supply board. The light bars on the monitor power supply board may be mounted along a long side or a short side of the television. A television of a general model has its long side placed along the horizontal direction and its short side placed along the vertical direction. By using the light bars arranged along the short side of the television as an example, generally, one light bar is mounted on each of two sides of the monitor power supply board. Herein, the luminance value of the display area on the periphery of the monitor is adjusted by changing current values of the light bars according to different image display modes, so as to change the luminance value of the display area on the periphery of the monitor, thereby alleviating the light leakage problem of the television screen.

In one of the embodiments, each light bar includes a first-area light bar that uses a first power supply driver and a second-area light bar that uses a second power supply driver, and the display area includes a first display area displayed by the first-area light bar and a second display area displayed by the second-area light bar; and in the luminance adjustment step, a current value of the first-area light bar is controlled by using the first power supply driver so as to adjust the luminance value of the first display area, and a current value of the second-area light bar is controlled by using the second power supply driver so as to adjust the luminance value of the second display area. The light bar is divided into the first-area light bar and the second-area light bar, and different power supply drivers are used to drive the first-area light bar and the second-area light bar respectively, so that the light bar mounted along the short side of the television can provide different display luminance in different areas, thereby alleviating the light leakage problem by using different display luminance.

In one of the embodiments, each light bar is parallel to the short side of the monitor, the first-area light bar is located at each of the two ends of the whole light bar, and the second-area light bar is located in the middle of the whole light bar; and the luminance adjustment step specifically includes: decreasing the current value of the first-area light bar if the image display mode is a full-black-screen display mode or a 16:9 display mode, so that the current value of the first-area light bar is less than the current value of the second-area light bar. By disposing two first-area light bars at both ends of the whole light bar and disposing the second-area light bar in the middle of the whole light bar, luminance values of areas at four corners of the television screen can be lower than luminance values of display areas on two sides of the television screen, thus solving the light leakage problem in the areas at the four corners of the television screen. Besides, the luminance values of the first area and the second area are adjusted so that the luminance values of the two areas are presented in a gradient form, and therefore, the light leakage problem on lateral sides of the television screen is also solved.

In one of the embodiments, the first-area light bar includes two first-area light bar parts that are located at both ends of the light bar respectively, the two first-area light bar parts occupy equal lengths on the whole light bar, and a ratio of the length occupied by each of the first-area light bar parts on the whole light bar to a length occupied by the second-area light bar on the light bar is 1:3. In a full-black image and a film image of 16:9 mode, the light leakage areas are located at two ends of the side of the television and each occupies approximately ⅕ of the side length of the television, and by disposing two first-area light bars at both ends of the light bar wherein the first-area light bar occupies ⅕ of the length of the light bar at each end, current values of the light leakage areas in the two modes can be reduced independently, thus desirably alleviating the light leakage phenomenon.

Referring to FIG. 2, which shows an embodiment of the present application, the light leakage problem of a television screen is alleviated by using a method of adjusting a luminance value of a display area on the periphery of a monitor according to an image display mode. Step S201: A current image display mode of a television is acquired, wherein the current image display mode is a 16:9 mode. Step S202: A system determines that in the current image display mode, the luminance values at four corner positions of the television screen need to be decreased. Step S203: The system decreases the output current value of a power supply driver of the first-area light bar to change the luminance values at the four corner positions of the television screen, wherein the method for decreasing the output current value may also be decreasing a voltage, increasing a resistance value, or the like. Till now, the process of alleviating monitor light leakage is finished.

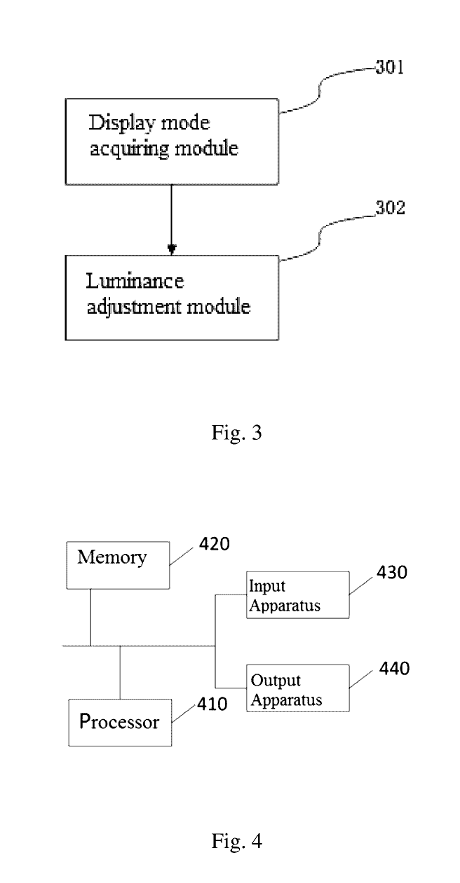

Referring to FIG. 3, an embodiment of the present application provides an apparatus for alleviating light leakage of a monitor, including: a display mode acquiring module 301, configured to acquire a current image display mode of the monitor; and a luminance adjustment module 302, configured to adjust a luminance value of a display area of the monitor according to the image display mode, wherein the display area is a screen edge area of the monitor.

In one of the embodiments, in the luminance adjustment module 302, the luminance value of the display area of the monitor is adjusted by changing current values of light bars mounted on a monitor power supply board.

In one of the embodiments, each light bar includes a first-area light bar that uses a first power supply driver and a second-area light bar that uses a second power supply driver, and the display area includes a first display area displayed by the first-area light bar and a second display area displayed by the second-area light bar; and in the luminance adjustment module, a current value of the first-area light bar is controlled by using the first power supply driver so as to adjust the luminance value of the first display area, and a current value of the second-area light bar is controlled by using the second power supply driver so as to adjust the luminance value of the second display area.

In one of the embodiments, each light bar is parallel to a short side of the monitor, the first-area light bar is located at each of the two ends of the whole light bar, and the second-area light bar is located in the middle of the whole light bar; and the luminance adjustment module specifically includes: decreasing the current value of the first-area light bar if the image display mode is a full-black-screen display mode or a 16:9 display mode, so that the current value of the first-area light bar is less than the current value of the second-area light bar.

In one of the embodiments, the first-area light bar includes two first-area light bar parts that are located at both ends of the light bar respectively, the two first-area light bar parts occupy equal lengths on the whole light bar, and a ratio of the length occupied by each of the first-area light bar parts on the whole light bar to a length occupied by the second-area light bar on the light bar is 1:3.

An embodiment of the present application provides a nonvolatile computer storage media having computer executable instructions stored thereon, wherein the computer executable instructions can perform any one of the methods for alleviating light leakage of a monitor in the foregoing embodiments of methods.

FIG. 4 shows the hardware configuration of a device for the method for alleviating light leakage of a monitor provided in the embodiments of the present application, as shown in FIG. 4, this device includes:
one or more processors 410 and a memory 420, in FIG. 4, one memory 410 is employed as an example.

The device for executing the method for alleviating light leakage of a monitor may further comprise: an input apparatus 430 and an output apparatus 440.

The processor 410, the memory 420, the input apparatus 430 and the output apparatus 440 may be connected via a bus or other means, in FIG. 4, a connection via a bus is taken as an example.

As a nonvolatile computer readable storage media, the memory 420 can be used to store nonvolatile software program, nonvolatile computer executable program and module, such as the program instructions/modules corresponding to the method for alleviating light leakage of a monitor in the embodiments of the present application (e.g., the display mode acquiring module 301 and luminance adjustment module 302 as shown in FIG. 3). The processor 410 executes various functions and applications of a server and data processing by running a nonvolatile software program, instructions and a module stored in the memory 420, so as to carry out the method for alleviating light leakage of a monitor in the embodiments of method.

The memory 420 may include a program storage area and a data storage area, wherein the program storage area can store an operating system, an application program required for at least one function; the data storage area can store the data created based on the use of the apparatus for alleviating light leakage of a monitor, or the like. Further, the memory 420 may include high-speed random access memory, and may further include nonvolatile memory, such as at least one disk storage device, flash memory device, or other nonvolatile solid-state memory devices. In some embodiments, the memory 420 optionally includes a memory remotely located with respect to the processor 410, which may be connected to an apparatus for alleviating light leakage of a monitor via a network. Examples of such network include, but not limited to, Internet, Intranet, local area network (LAN), mobile communication network, and combinations thereof.

The input apparatus 430 may receive the input numbers or characters information, as well as key signal input associated with user settings of the apparatus for alleviating light leakage of a monitor and function control. The output apparatus 440 may include a display screen or other display device.

The one or more modules are stored in the memory 420, and when being executed by the one or more processors 410, execute the method for alleviating light leakage of a monitor according to the above embodiments of method.

The above mentioned products can perform the method provided by the embodiments of the present application, and they have the function modules and beneficial effects corresponding to this method. With respect to the technical details that are not detailed in this embodiment, please refer to the methods provided by the embodiments of the present application.

The electronic device according to the embodiments of the present application may have many forms, for example, including, but not limited to:

(1) mobile communication device: the characteristic of such device is: it has the function of mobile communication, and takes providing voice and data communications as the main target. Such type of terminal includes: smart phones, multimedia phones, feature phones and low-end mobile phones.

(2) ultra mobile PC device: this type of device belongs to the category of personal computer, it has the capabilities of computing and processing, and generally has the feature of mobile Internet access. Such type of terminal includes: PDA, MID and UMPC devices.

(3) portable entertainment device: this type of device can display and play multimedia content. Such type of device includes: audio players, video players, handheld game consoles, e-books, as well as smart toys and portable vehicle navigation devices.

(4) server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.

(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

Finally, it should be noted that: the above embodiments are merely provided for describing the technical solutions of the present invention, but not intended to limit thereto; although the present invention has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. A method for alleviating light leakage of a monitor, which is applicable to a terminal, comprising:
a display mode acquiring step: acquiring a current image display mode of the monitor; and
a luminance adjustment step: adjusting a luminance value of a display area of the monitor according to the image display mode, wherein the display area is a screen edge area of the monitor.

2. The method for alleviating light leakage of a monitor according to claim 1, wherein:
in the luminance adjustment step, the luminance value of the display area of the monitor is adjusted by changing current values of light bars mounted on a monitor power supply board.

3. The method for alleviating light leakage of a monitor according to claim 2, wherein:
each of the light bars comprises a first-area light bar that uses a first power supply driver and a second-area light bar that uses a second power supply driver, and the display area comprises a first display area displayed by the first-area light bar and a second display area displayed by the second-area light bar; and
in the luminance adjustment step, a current value of the first-area light bar is controlled by using the first power supply driver so as to adjust the luminance value of the first display area, and a current value of the second-area light bar is controlled by using the second power supply driver so as to adjust the luminance value of the second display area.

4. The method for alleviating light leakage of a monitor according to claim 3, wherein:
each of the light bars is parallel to a short side of the monitor, the first-area light bar is located at each of two ends of the whole light bar, and the second-area light bar is located in the middle of the whole light bar; and
the luminance adjustment step comprises: decreasing the current value of the first-area light bar if the image display mode is a full-black-screen display mode or a 16:9 display mode, so that the current value of the first-area light bar is less than the current value of the second-area light bar.

5. The method for alleviating light leakage of a monitor according to claim 4, wherein:
the first-area light bar comprises two first-area light bar parts that are located at both ends of the light bar respectively, the two first-area light bar parts occupy equal lengths on the light bar, and a ratio of the length occupied by each of the first-area light bar parts on the light bar to a length occupied by the second-area light bar on the light bar is 1:3.

6. A nonvolatile computer storage media, which has computer executable instructions stored thereon, wherein the computer executable instructions are configured to:
a display mode acquiring step: acquiring a current image display mode of the monitor; and
a luminance adjustment step: adjusting a luminance value of a display area of the monitor according to the image display mode, wherein the display area is a screen edge area of the monitor.

7. The nonvolatile computer storage media according to claim 6, wherein:
in the luminance adjustment step, the luminance value of the display area of the monitor is adjusted by changing current values of light bars mounted on a monitor power supply board.

8. The nonvolatile computer storage media according to claim 7, wherein:
each of the light bars comprises a first-area light bar that uses a first power supply driver and a second-area light bar that uses a second power supply driver, and the display area comprises a first display area displayed by the first-area light bar and a second display area displayed by the second-area light bar; and
in the luminance adjustment step, a current value of the first-area light bar is controlled by using the first power supply driver so as to adjust the luminance value of the first display area, and a current value of the second-area light bar is controlled by using the second power supply driver so as to adjust the luminance value of the second display area.

9. The nonvolatile computer storage media according to claim 8, wherein:
each of the light bars is parallel to a short side of the monitor, the first-area light bar is located at each of two ends of the whole light bar, and the second-area light bar is located in the middle of the whole light bar; and
the luminance adjustment step comprises: decreasing the current value of the first-area light bar if the image display mode is a full-black-screen display mode or a 16:9 display mode, so that the current value of the first-area light bar is less than the current value of the second-area light bar.

10. The nonvolatile computer storage media according to claim 9, wherein:
the first-area light bar comprises two first-area light bar parts that are located at both ends of the light bar respectively, the two first-area light bar parts occupy equal lengths on the light bar, and a ratio of the length occupied by each of the first-area light bar parts on the light bar to a length occupied by the second-area light bar on the light bar is 1:3.

11. An electronic device, comprising:
one or more processors; and
a memory; wherein the memory is stored with instructions executable by the one or more processors, the instructions are configured to execute:
a display mode acquiring step, acquiring a current image display mode of the monitor; and
a luminance adjustment step, adjusting a luminance value of a display area of the monitor according to the image display mode, wherein the display area is a screen edge area of the monitor.

12. The electronic device according to claim 11, wherein:
in the luminance adjustment step, the luminance value of the display area of the monitor is adjusted by changing current values of light bars mounted on a monitor power supply board.

13. The electronic device according to claim 12, wherein:
each of the light bars comprises a first-area light bar that uses a first power supply driver and a second-area light bar that uses a second power supply driver, and the display area comprises a first display area displayed by the first-area light bar and a second display area displayed by the second-area light bar; and
in the luminance adjustment step, a current value of the first-area light bar is controlled by using the first power supply driver so as to adjust the luminance value of the first display area, and a current value of the second-area light bar is controlled by using the second power supply driver so as to adjust the luminance value of the second display area.

14. The electronic device according to claim 13, wherein:
each of the light bars is parallel to a short side of the monitor, the first-area light bar is located at each of two ends of the whole light bar, and the second-area light bar is located in the middle of the whole light bar; and
the luminance adjustment step comprises: decreasing the current value of the first-area light bar if the image display mode is a full-black-screen display mode or a 16:9 display mode, so that the current value of the first-area light bar is less than the current value of the second-area light bar.

15. The electronic device according to claim 14, wherein:
the first-area light bar comprises two first-area light bar parts that are located at both ends of the light bar respectively, the two first-area light bar parts occupy equal lengths on the light bar, and a ratio of the length occupied by each of the first-area light bar parts on the light bar to a length occupied by the second-area light bar on the light bar is 1:3.
